(19) United States
(12) Patent Application Publication
(10) Pub. No.: US 2006/0292367 A1
(43) Pub. Date: Dec. 28, 2006

(54) Anti slipping agent

(75) Inventors: Sang Won Seol, Cheonan-si (KR); Myung Sun Gong, Seoul (KR); Chil Won Lee, Dangjin-gun (KR)

Correspondence Address: FROMMER LAWRENCE & HAUG, 745 FIFTH AVENUE- 10TH FL., NEW YORK, NY, 10151, US

(73) Assignee: KMG INC.

(21) Appl. No.: 11/475,512

(22) Filed: Jun. 27, 2006

(30) Foreign Application Priority Data
Jun. 28, 2005 (KR) 10-2005-0056131

(51) Int. Cl. B32B 7/12; B32B 15/04; D04H 13/00; B32B 19/00

(52) U.S. Cl. 428/357; 428/349; 428/292.1

(57) ABSTRACT

The present invention relates to an anti-slip agent having a sufficiently large adhesion strength while being easily peeled off, that is, an anti-slip agent having a much larger resistance to the external force applied along the adhesion surface than to the external force applied perpendicular to the surface. The anti-slip agent of the present invention comprises 10 to 40 wt % of a volatile solvent, 1 to 5 wt % of a crystallization inhibitor, 1 to 10 wt % of a humectant, 0.5 to 5 wt % of a preservative, 0.1 to 1 wt % of a leveling agent, 1 to 10 wt % of a viscosity modifier and a biodegradable polymer material as residual.

### TECHNICAL FIELD

The present invention relates to an anti-slip agent. More particularly, the present invention relates to an anti-slip agent having a sufficiently large adhesion strength while it is easily repeelable, that is, an anti-slip agent having a much larger resistance to the external force applied along the adhesion surface than to the external force applied perpendicular to the surface.

### BACKGROUND ART

Several anti-slip systems are used to prevent slipping of packaged or palletized goods during transportation and storage, and thus, to improve workability and safety and minimize personal and material loss.

Of the anti-slip systems, the taping system utilizing polypropylene (PP) band, stretch film, etc., is known to have problems—replacement of expensive films, high maintenance cost, need for additional space, noise, high risk of accident, generation of an enormous amount of wastes, etc. Therefore, utilization of the taping system is on the decrease and most of companies are switching from banding machine or stretch wrapping machine to the system using an anti-slip agent.

An anti-slip agent is an adhesive with a sufficiently large adhesion strength while it can be easily peeled off. That is, it has a much larger resistance to the external force applied along the adhesion surface than to the external force applied perpendicular to the surface. 3M of USA, the world's leading manufacturer of adhesives and bonds, produces an aerosol-type anti-slip agent called the “Shipping-Mate Palletizing Adhesive.” However, this anti-slip agent has a problem that volatile organic compounds (VOC) are generated during the manufacture process.

Of the anti-slip systems, the adhesive system uses adhesives like a hot melt adhesive. The hot melt adhesive, which was developed by Hot Melt Technologies, has strong initial adhesion. Although the initial work is easy, the packaging material is not easily removed. That is, because of too strong adhesion, the packaging material tends to be torn or contaminated. And, the expensive coating apparatus increases the initial expense.

As another adhesive system, the water-based anti-slip system uses water-soluble or water-dispersible adhesives like Keytech's Lock & Pop and Gluefast's Skid-Lock. But, poor slip resistance, poor water resistance and weather resistance, long drying time, etc. remain as problems.

Recently, environmental regulations by the ISO (International Standardization Organization) and advanced countries are becoming stricter. Especially, regulations are being extended from final products to raw materials, production processes, logistics, spending, disposal and recovery. Further, use of organic solvents may cause the problems of air pollution, poor working environment, fire, etc.

[Disclosure]

[Technical Problem]

An object of the present invention is to provide an environment-friendly anti-slip agent made of a stable, natural, biodegradable polymer material, which is flexible and solid and offers superior slip resistance.

[Technical Solution]

Anti-slip adhesives, which are used to prevent the collapse of pallet loads, can be prepared taking advantage of the property of conventional adhesives, which glue and fix two adherends. It is essential for an anti-slip adhesive to have a sufficiently large adhesion strength while it can be easily peeled off. That is, it is required to have a much larger resistance to the external force applied along the adhesion surface than to the external force applied perpendicular to the surface.

By using an environment-friendly, water-based adhesive as main component and adding various supplementary additives, the present invention provides a biodegradable anti-slip agent for use in the anti-slip system. The anti-slip agent of the present invention has superior water resistance and weather resistance, can be reused several times and is applicable to various packing materials made of paper, polyethylene, polypropylene, etc.

### DESCRIPTION OF DRAWINGS

FIG. 1 shows the adhesion strength of the anti-slip agent of the present invention, which comprises a viscosity modifier, (Example 1) and that of the anti-slip agent not comprising a viscosity modifier (Comparative Example 1).

FIG. 2 shows the adhesion strength of the anti-slip agent of the present invention, which comprises a biodegradable polymer material only, (Example 1) ad those of the anti-slip agents in which part of the biodegradable polymer material is replaced by maltodextrin (Example 2: maltodextrin 10%, Example 3: maltodextrin 20%, Example 4: maltodextrin 30%).

FIG. 3 shows the adhesion strength of the anti-slip agent of the present invention at various contents of maltodextrin, which is used as crystallization inhibitor.

FIG. 4 shows the change of the adhesion strength of the anti-slip agent of the present invention (Example 1) with time.

FIG. 5 shows the rate of solvent evaporation of the anti-slip agent of the present invention (Example 1) with time, after the anti-slip agent has been applied.

FIG. 6 schematically illustrates the measurement of adhesion strength of an anti-slip agent, which has been applied between two polyethylene substrates.

### BEST MODEL

The anti-slip agent according to the present invention comprises 10 to 40 wt % of a volatile solvent, 1 to 5 wt % of a crystallization inhibitor, 1 to 10 wt % of a humectant, 0.5 to 5 wt % of a preservative, 0.1 to 1 wt % of a leveling agent, 1 to 10 wt % of a viscosity modifier and a biodegradable polymer material as residual.

Hereinafter, the embodiments of the present invention will be described in detail with reference to preferred examples and accompanying drawings.

The anti-slip agent according to the present invention is characterized by comprising 10 to 40 wt % of a volatile solvent, 1 to 5 wt % of a crystallization inhibitor, 1 to 10 wt % of a humectant, 0.5 to 5 wt % of a preservative, 0.1 to 1 wt % of a leveling agent, 1 to 10 wt % of a viscosity modifier and a biodegradable polymer material as residual.

The crystallization inhibitor prevents water absorption after the volatile solvent is evaporated from the anti-slip agent, thereby preventing solidification or crystallization of the biodegradable polymer material. The crystallization inhibitor may be at least one selected from the group consisting of sorbitol, maltodextrin and xylitol. The crystallization inhibitor may be comprised in 1 to 5 wt % per 100 wt % of the anti-slip agent. If the crystallization inhibitor used less than 1 wt %, adhesion strength may be reduced greatly. In contrast, if it is used more than5 wt %, the anti-slip agent may become highly hygroscopic or brittle at low temperature.

The humectant maintains adhesivity even after the volatile solvent has been evaporated and may be at least one polyhydric alcohol selected from the group consisting of glycerin, triethanolamine, ethylene glycol, propylene glycol, diethylene glycol, triethylene glycol; tetraethylene glycol, 1,1,1-trimethylolpropane, pentaerythritol, neopentyl glycol and diethanolamine. The humectant may be used in 1 to 10 wt % per 100 wt % of the anti-slip agent. If the humectant is used less than 1 wt %, the anti-slip agent may be solidified after the volatile solvent is evaporated, resulting in decreased adhesivity. In contrast, if it is used more than 10 wt %, viscosity tends to increase more than required.

The preservative prevents biodegradable polymer materials or other substances from being decayed. For the preservative, common preservatives such as formalin and salicylic acid may be used. The preservative may be used in the amount of 0.5 to 5 wt % per 100 wt % of the anti-slip agent. If the preservative is used less than 0.5 wt %, the anti-slip agent may be decayed or deteriorated during storage. In contrast, if it is used more than 5 wt %, the anti-slip agent may become toxic.

The leveling agent is a water-soluble solution having a large surface tension. It is a surfactant that reduces surface tension at the adhesive surface, thereby enabling formation of uniform film, increasing adhesion area with polyethylene, enlarging surface area, and thus, increasing evaporation rate. For the leveling agent, sodium dodecylsulfate, sodium stearate, Tween, Span, etc., may be used. The leveling agent may be used in the amount of 0.1 to 1 wt % per 100 wt % of the anti-slip agent. If the leveling agent is used less than 0.1 wt %, the adhesive surface of the anti-slip agent may become non-uniform. In contrast, if it is used more than 1 wt %, adhesion strength may be decreased.

The viscosity modifier improves adhesion strength of the anti-slip agent. Used as solid in small amount, it increases viscosity of the anti-slip agent. The viscosity modifier may be at least one water-soluble polymer selected from the group consisting of polyvinylpyrrolidone, polyvinylalcohol, hydroxyethylcellulose, methoxypropylcellulose, polyacrylamide, polyacrylic acid and polymethacrylic acid. The viscosity modifier may be used in the amount of 1 to 10 wt % per 100 wt % of the anti-slip agent. If the viscosity modifier is used less than 1 wt %, the anti-slip agent may become too fluid because of low viscosity. In contrast, if it is used more than 10 wt %, the anti-slip agent may become viscous. Preferably, the viscosity modifier may be polyvinylpyrrolidone. There are many polyvinylpyrrolidones, depending on molecular weight. Most preferably, a low molecular weight polyvinylpyrrolidone having a molecular weight in the range of from 9,000 to 12,000 may be used, considering the peeling characteristics, etc.

Mostly, water is used as a volatile solvent. Considering compatibility with the additive, solubility, evaporation rate, etc., at least one nontoxic, low volatile alcohol selected from the group consisting of methanol, ethanol, n-propanol, isopropanol, n-butanol, sec-butanol, isobutanol and tert-butanol may be added as cosolvent. Preferably, the solvent may be a 60-70:30 mixture of water and alcohol based on weight. The solvent mixture may comprise other afore-mentioned components as residual. The solvent may be used in 10 to 40 wt % per 100 wt % of the anti-slip agent. If the volatile solvent is used less than 10 wt %, applying property, etc., may be poor because other components are not dissolved sufficiently. In contrast, if it is used more than 40 wt %, adhesion strength may not be sufficient.

The biodegradable polymer material is a material that offers adhesivity to the anti-slip agent of the present invention. One that can be biologically degraded in nature may be used, considering environmental influence. At least one selected from the group consisting of a plant (microorganism included) polysaccharide such as dextrin, wheat flour, starch paste, guar gum, Arabic gum and xanthane gum; and an animal protein derivative such as casein and gelatin may be used for the biodegradable polymer material. The biodegradable polymer material may be used as residual, excluding the aforementioned other components. However, if the content of the biodegradable polymer material is too low, sufficient slip resistance cannot be attained because of low initial adhesion strength. In contrast, if it is too high, the anti-slip agent may become overly viscous, resulting in crystallization and brittleness at low temperature.

Preferably, the final anti-slip agent product in accordance with the present invention has a weight proportion of the solid contents to the volatile solvent of about 7:3.

Practical and preferred embodiments of the present invention are illustrated as shown in the following examples. However, those skilled in the art may, in consideration of this disclosure, make modifications and improvements within the spirit and scope of the present invention.

### EXAMPLE 1

7.5 wt % of distilled water was added into a mixing tank. 2 wt % of polyvinylpyrrolidone (PVP K-15) was added as viscosity modifier and stirring was performed until it was dissolved completely. The solution was heated to about 50° C. and 66 wt % of corn syrup (water content: 21.5%) and 3 wt % of maltodextrin were slowly added. When the solid contents were almost dissolved, the solution was cooled to room temperature, while continuing the stirring. Then, 1 wt % of Tween 80 and 2 wt % of sodium salicylate were added as leveling agent and antiseptic, respectively, and stirring was performed. Subsequently, 17.5 wt % of a methanol (50)/ethanol (50) solvent mixture was added. 1 wt % of dissolved glycerin was slowly added to the solution as humectant, while stirring.

### EXAMPLE 2

The procedure of Example 1 was repeated, except that 68 wt % of corn syrup and 1 wt % of maltodextrin were used.

### EXAMPLE 3

The procedure of Example 1 was repeated, except that 63 wt % of corn syrup and 1 wt % of maltodextrin were used.

### COMPARATIVE EXAMPLE 1

The procedure of Example 1 was repeated, except that maltodextrin was not used and 69 wt % of corn syrup was used.

### COMPARATIVE EXAMPLE 2

The procedure of Example 1 was repeated, except that the humectant was not used and 67 wt % of corn syrup was used.

### COMPARATIVE EXAMPLE 3

The procedure of Example 1 was repeated, except that the viscosity modifier was not used and 68 wt % of corn syrup was used.

### COMPARATIVE EXAMPLE 4

The procedure of Example 1 was repeated, except that alcohol was not used in the volatile solvent but 25 wt % of water was used.

### COMPARATIVE EXAMPLE 5

The procedure of Example 1 was repeated, except that the leveling agent was not used and 67 wt % of corn syrup was used.

### COMPARATIVE EXAMPLE 6

The procedure of Example 1 was repeated, except that the crystallization inhibitor, the humectant, the viscosity modifier and the leveling agent were not used, 73 wt % of corn syrup was used and 17.5 wt % of alcohol mixture and 7.5 wt % of water were used as volatile solvent.

### EXPERIMENTAL EXAMPLE

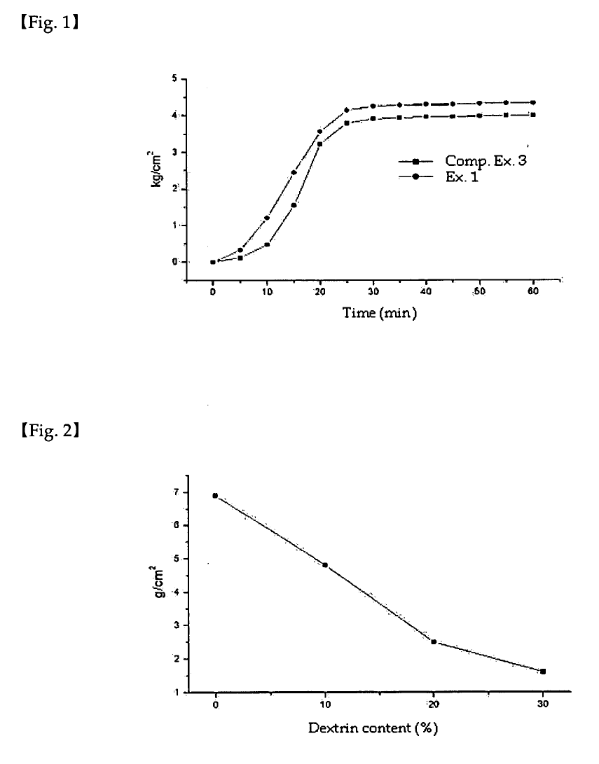

Peel strength and adhesion strength were measured as follows. As shown in FIG. 6, two polyethylene substrates were glued by applying the anti-slip agent to a thickness of 50 μm between the substrates. Measurement was made under the condition of 20° C. and R.H. 47%, by applying force vertically and horizontally, 30 minutes after the anti-slip agent had been applied. The result is given in FIG. 1 to FIG. 5.

TABLE 1

| | | | | | | | |
|---|---|---|---|---|---|---|---|
| Contents | Corn | | | Viscosity | Alcohol | | Leveling |
| (wt %) | syrup | Maltodextrin | Humectant | controller | mixture | Water | agent |

| | | | | | | | |
|---|---|---|---|---|---|---|---|
| Ex. 1 | 66 | 3 | 1 | 2 | 17.5 | 7.5 | 1 |
| Ex. 2 | 68 | 1 | 1 | 2 | 17.5 | 7.5 | 1 |
| Ex. 3 | 63 | 6 | 1 | 2 | 17.5 | 7.5 | 1 |
| Comp. Ex. 1 | 69 | 0 | 1 | 2 | 17.5 | 7.5 | 1 |
| Comp. Ex. 2 | 67 | 3 | 0 | 2 | 17.5 | 7.5 | 1 |
| Comp. Ex. 3 | 67 | 3 | 1 | 0 | 17.4 | 7.5 | 1 |
| Comp. Ex. 4 | 66 | 3 | 1 | 2 | 0 | 25 | 1 |
| Comp. Ex. 5 | 67 | 3 | 1 | 2 | 17.5 | 7.5 | 0 |
| Comp. Ex. 6 | 75 | 0 | 0 | 0 | 17.5 | 7.5 | 0 |

Antiseptic 2%

The anti-slip agent of the present invention comprised a biodegradable polymer material, maltodextrin, water and alcohol. In addition, many additives were added to improve applying characteristics and durability.

As shown in FIG. 1, slip resistance varied depending on the presence of the viscosity modifier (Example 1 and Comparative Example 3). That is, addition of 5% of poly(vinylpyrrolidione) improved slip resistance, as shown in the figure. Also, the increase in initial adhesion strength is expected to improve working speed. There was little difference in peel strength. To conclude, the anti-slip agent of the present invention, which comprised a viscosity modifier, (Example 1) showed better adhesion strength.

As shown in FIG. 2, the anti-slip agents of Examples 1 to 3 and Comparative Example 1 showed proportionally decreased vertical adhesion strength as the content of maltodextrin increased. That is, vertical adhesion strength decreased as the content of corn syrup or the biodegradable polymer material decreased.

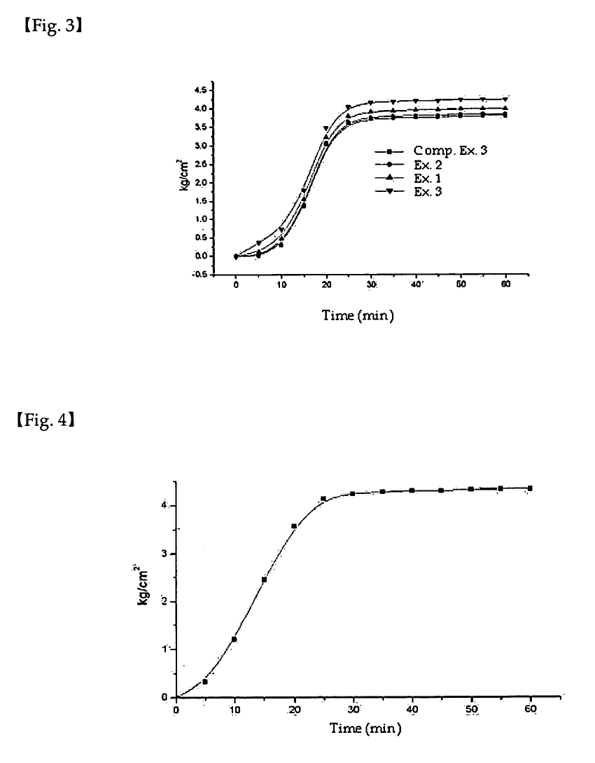

As shown in FIG. 3, the anti-slip agents of Examples 1 to 3 and Comparative Example 1 showed the best horizontal adhesion strength when the content of maltodextrin was highest (Example 3, 6 wt %). It decreased as the content of maltodextrin decreased (Example 1, 3 wt %; Example 2, 1 wt %) and was lowest when maltodextrin was not used (Comparative Example 1). To conclude, the best result was obtained when corn syrup, or a biodegradable polymer material, was used along with maltodextrin because crystallization was prevented.

FIG. 4 shows the change of the adhesion strength of the anti-slip agent of the present invention (Example 1) with time. As shown in FIG. 4, adhesion strength increased with time, but it remained almost constant from about 30 minutes. This means that the adhesion strength increases at the early stage of application and reaches the highest value at about 30 minutes. Consequently, transportation or other handling is possible about 30 minutes after the application.

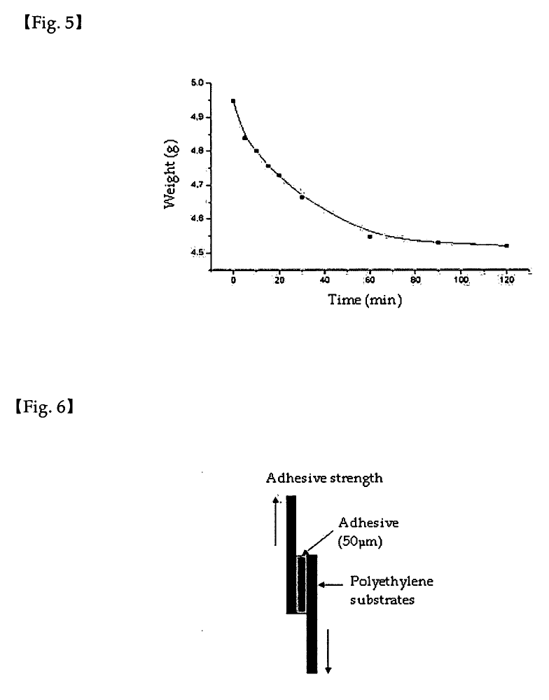

FIG. 5 shows the rate of solvent evaporation of the anti-slip agent of the present invention (Example 1) with time, after the anti-slip agent was applied. During the first 20 minutes, the solvent evaporated very quickly, but it evaporated slowly thereafter. This means that the anti-slip agent dries quickly at the early stage of application. Considering this along with the result shown in FIG. 4, the anti-slip agent dries quickly within 20 minutes after application, shows the highest adhesion strength after 30 minutes and dries further with time passage. After about 30 minutes, the maximum adhesion strength is maintained without regard to evaporation of the solvent. Therefore, quick transportation or other handling can be done after the application.

The anti-slip agent of the present invention is also advantageous in that, since a biodegradable polymer material is used, it may replace conventional acrylic anti-slip agents as environment-friendly product. That is, it offers superior safety and does not cause any environmental pollution.

### INDUSTRIAL APPLICABILITY

The anti-slip agent of the present invention is advantageous in that, because it has sufficiently large adhesion strength while it can be easily peeled off, it is effective in preventing the collapse of pallet loads with large surface friction. Therefore, the anti-slip agent of the present invention is effective in facilitating loading works and improving safety in industrial fields.

The anti-slip agent of the present invention is also advantageous in that an adhesive layer can be formed without using an organic solvent or hydrophilic synthetic fiber. Especially, the present invention is advantageous in that the adhesive layer is washable with water and the washing solution is biodegradable.

Those skilled in the art will appreciate that the concepts and specific embodiments disclosed in the foregoing description may be readily utilized as a basis for modifying or designing other embodiments for carrying out the purposes of the present invention. Those skilled in the art will also appreciate that such equivalent embodiments do not depart from the spirit and scope of the present invention as set forth in the appended claims.

1. An anti-slip agent comprising 10 to 40 wt % of a volatile solvent, 1 to 5 wt % of a crystallization inhibitor, 1 to 10 wt % of a humectant, 0.5 to 5 wt % of a preservative, 0.1 to 1 wt % of a leveling agent, 1 to 10 wt % of a viscosity modifier and a biodegradable polymer material as residual.

2. The anti-slip agent as set forth in claim 1, wherein the biodegradable polymer material is at least one selected from the group consisting of a plant (microorganism included) polysaccharide such as corn syrup, dextrin, wheat flour, starch paste, guar gum, Arabic gum and xanthane gum; and an animal protein derivative such as casein and gelatin.

3. The anti-slip agent as set forth in claim 2, wherein the biodegradable polymer material is corn syrup.

4. The anti-slip agent as set forth in claim 1, wherein the crystallization inhibitor is at least one selected from the group consisting of sorbitol, maltodextrin and xylitol.

5. The anti-slip agent as set forth in claim 1, wherein the humectant is at least one polyhydric alcohol selected from the group consisting of glycerin, triethanolamine, ethylene glycol, propylene glycol, diethylene glycol, triethylene glycol, tetraethylene glycol, 1,1,1-trimethylolpropane, pentaerythritol, neopentyl glycol and diethanolamine.

6. The anti-slip agent as set forth in claim 1, wherein the preservative is formalin or salicylic acid.

7. The anti-slip agent as set forth in claim 1, wherein the leveling agent is at least one selected from the group consisting of sodium dodecylsulfate, sodium stearate, Tween and Span.

8. The anti-slip agent as set forth in claim 1, wherein the viscosity modifier is at least one selected from the group consisting of polyvinylpyrrolidone, polyvinylalcohol, hydroxyethylcellulose, methoxypropylcellulose, polyacrylamide, polyacrylic acid and polymethacrylic acid.

9. The anti-slip agent as set forth in claim 1, wherein the volatile solvent is a 60-70:30 mixture of water and alcohol based on weight.

10. The anti-slip agent as set forth in claim 9, wherein the alcohol is at least one selected from the group consisting of methanol, ethanol, n-propanol, isopropanol, n-butanol, sec-butanol, isobutanol and tert-butanol.

11. The anti-slip agent as set forth in claim 1, wherein the anti-slip agent has a weight proportion of the solid contents to the volatile solvent of about 7:3.
